(19) United States
(12) Patent Application Publication
(10) Pub. No.: US 2009/0258271 A1
(43) Pub. Date: Oct. 15, 2009

(54) Fuel Cell Comprising a Gas Coolant Cooling Device

(75) Inventor: Guillaume ROBERGE, Bourgoin (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/251,610

(22) Filed: Oct. 15, 2008

(30) Foreign Application Priority Data
Oct. 17, 2007 (FR) 07 58390

(51) Int. Cl. H01M 8/04

(52) U.S. Cl. 429/26

(57) ABSTRACT

A fuel cell comprising a plurality of adjacent cell elements forming a stack of cell elements, a device for cooling said stack of cell elements by forced heat exchange with a coolant gas such as air by means of at least one generator of a gas flow along an airstream axis, which fuel cell comprises at least one gas flow stator member placed between the stack of cell elements and the generator, the stator member comprising at least one static blade formed to reduce the unevenness of the gas flow rate originating from the generator in a direction substantially perpendicular to the axis of the flow before it arrives at the stack.

### PRIORITY CLAIM

This application claims the benefit of priority under 35 U.S.C. § 119 (a) and (b) to French Patent Application No. 07 58390, filed Oct. 17, 2007, the entire contents of which are incorporated herein by reference.

### BACKGROUND

### Field of the Invention

The present invention relates to a fuel cell comprising a device for cooling by coolant gas.

The invention relates more particularly to a fuel cell comprising a plurality of adjacent cell elements forming a stack of cell elements, a device for cooling said stack of cell elements by forced heat exchange with a coolant gas such as air by means of at least one generator of a gas flow along an airstream axis.

To cool the stacks of cell elements forming a fuel cell, it is a known practice to use forced air which travels between the single-pole fuel cell plates or double-pole fuel cell plates forming the individual cell elements of the fuel cell.

In a known geometry, the outer faces of the single-pole or double-pole plates of a fuel cell comprise cooling fins. The cooling fins of two plates of two adjacent cell elements interact in contact to form guide channels for the forced cooling air. Preferably, the forced air flow is substantially parallel to the cooling channels.

It has been found that the cooling of the stack of cell elements is not totally satisfactory notably because of the disparities in terms of maximum temperature reached within adjacent cell elements of one and the same stack. The applicant has notably found a large unevenness of cooling depending on the zones of the stack of cell elements.

This results in deteriorations in the performance of the stack.

To attenuate these disparities, a known solution consists in redefining the geometry of the fins forming the cooling channels. This solution is however complex and potentially costly.

The solution consisting in acting upstream on the flow generated by the fans has hitherto been set aside because it is likely to generate additional pressure losses in the cooling circuit or an increased electricity consumption of said fans.

One object of the present invention is to alleviate all or a portion of the disadvantages of the prior art listed above.

For this purpose, the fuel cell according to the invention, furthermore complying with the generic definition given thereto by the above preamble, is essentially remarkable in that it comprises at least one gas flow stator member placed between the stack of cell elements and the generator, the stator member comprising at least one static blade formed to reduce the unevenness of the gas flow rate originating from the generator in a direction substantially perpendicular to the axis of the flow before it arrives at the stack.

Furthermore, embodiments of the invention may include one or more of the following features:
the blade or blades of the stator are curved in a first direction substantially perpendicular to the axis of the flow and in a second direction substantially parallel to the axis of the flow, in order to redirect at least a portion of the gas flow having a relatively greater flow rate toward at least a portion of the flow having a relatively smaller flow rate,
the generator of a gas flow is a blowing or sucking rotor comprising at least one rotating blade connected to a rotating hub and the static blade or blades of the stator are curved in order to redirect a portion of the flow situated relatively distant from the axis of the flow passing by the rotating hub to a zone of the flow situated relatively closer to the axis of the flow passing by the rotating hub,
the generator of a gas flow is spaced from the stack at a distance of between 15 and 60 mm and preferably of the order of 30 mm,
the flow stator member is spaced from the stack at a distance of more than 10 mm and preferably of between 20 and 35 mm,
the flow stator member comprises a plurality of static blades curved in a symmetrical manner about an axis of revolution substantially indistinguishable from the axis of the cooling gas flow passing by the central portion of the generator,
the flow stator member comprises six to eight static blades,
the static blades of the stator member are each connected to an outer frame (but not to a central hub),
the fuel cell comprises several adjacent gas flow generators designed to cool respectively corresponding adjacent zones of the stack and comprises a respective stator member associated with each generator of a gas flow,
the fuel cell is of the proton-exchange membrane type.

### BRIEF DESCRIPTION OF THE FIGURES

Other particularities and advantages will appear on reading the following description, made with reference to the figures in which:

FIG. 1 represents a schematic and partial view in perspective of an exemplary fuel cell furnished with a cooling device according to the invention,

FIG. 2 represents a view in perspective illustrating a possible and nonlimiting variant embodiment of a detail of FIG. 1 (stator member),

FIG. 3 represents two curves of velocity profiles of the cooling gas of the various channels of a fuel cell cell element, respectively with the invention (the curve passing through the dots) and without the invention (the curve passing through the crosses).

### DETAILED DESCRIPTION OF THE INVENTION

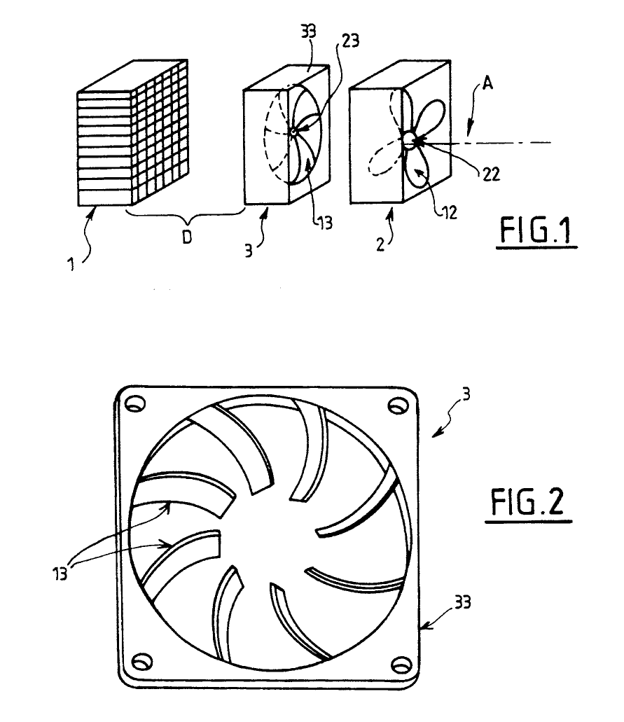

In the exemplary embodiment illustrated in FIG. 1, a fuel cell is represented solely and symbolically by its stack 1 of individual cell elements and the cooling device of the associated stack.

The fuel cell comprises a device for cooling said stack 1 of cell elements by forced heat exchange with a coolant gas such as air by means of at least one generator 2 of a gas flow along an axis A. The generator 2 is for example a fan or equivalent.

According to the invention, the fuel cell comprises at least one gas flow stator member 3 placed statically between the stack 1 of cell elements and the generator 2. The stator member 3 comprises at least one static blade 13 formed to reduce the unevenness of the gas flow rate originating from the generator 2 in a direction substantially perpendicular to the axis A of the flow before it arrives at the stack 1.

For example, and as can be seen in the possible example of FIG. 2, the flow stator member 3 may comprise a plurality of static blades 13 (for example six to eight) which may be curved in a symmetrical manner about an axis of revolution. Preferably this axis of revolution is, in the installed position, substantially indistinguishable from the axis A of the cooling gas flow passing through the central portion (hub) of the generator 2.

Preferably, the static blades 13 of the stator member 3 are each connected to an outer frame 33 but not to a central fixed hub (FIG. 2).

Preferably, the blades 13 of the stator 3 are curved in a first direction substantially perpendicular to the axis A of the flow and in a second direction substantially parallel to the axis A of the flow in order to redirect at least one zone of the gas flow having a relatively stronger flow rate toward at least a zone of the flow having a relatively weaker flow rate.

For example, the stator 3 redirects a portion of the periphery of the flow (relatively distant from the central longitudinal axis of symmetry of the flow) toward a more central zone of the flow (relatively closer to the central longitudinal axis A of symmetry of the flow).

The flow generator 2 (fan) is spaced from the stack 1 at a distance preferably between 15 and 60 mm and still more preferably of the order of 30 mm.

The stator member is for its part spaced from the stack 1 at a distance D of more than 10 mm and preferably of between 20 and 35 mm.

For example, the stator member 3 may have a width or thickness of 12 mm and be placed against the fan 2, on the discharge side of the latter.

The applicant has notably found that the invention makes it possible to even out the flow into the cooling channels by causing the zones less well supplied, that are situated in the extension of the central axis of the fan, to disappear or diminish. Specifically, the stator makes it possible to send an air flow rate at a speed of the order of 4 m/s into the zone situated in the extension of the axis of the fan 2 while, in the same configuration with no stator placed according to the invention, it is possible to observe channels in which the speed of the airstream is less than 1 m/s and even virtually zero.

The stator member 3 therefore induces a reduction of the speeds in the channels of the ends of the stack plates (at a distance from the central portion) to the benefit of the central portion. It should be noted that the reduction in the speeds in the peripheral channels remains acceptable because in practice the invention does not cause the speed of air stream in the latter to fall to less than 3 m/s approximately.

Therefore, certain channels called central channels (the axis of the fan) have their cooling air supply increase from 1 m/s to more than 4 m/s thanks to the invention.

The distance of the stator member 3 relative to the plates is preferably at least 10 mm in order to allow notably a more even and stabilized establishment of the air flow leaving the stator member 3.

The invention has other advantages. Therefore, the arrangement does not seem to induce acoustic disturbance or extra consumption of the fans due to the presence of the stator members 3, or significant pressure losses.

Anemometric tests on a MOBIXANE (registered trademark) fuel cell system of the company Axane have made it possible to map precisely the speeds leaving the cooling channels (in the center of each channel, 4 mm from the exit). The invention makes it possible to considerably limit the disparities of flow rate within the channels. Specifically, it is possible to note that the zones situated in the extension of the central portions (hubs) of the fans 2 are better supplied according to the invention (approximately 4 to 5 m/s compared with 1 to 2 m/s without the invention). The stators 3 therefore make it possible to even out the cooling flow rate. Paradoxically, the invention does not create a great increase in pressure losses, and therefore no significant reduction in the overall cooling flow rate as could be expected in principle. Specifically, the average air flow rate remains substantially identical in both configurations (8.27 m/s without the invention and 8.35 m/s with the invention).

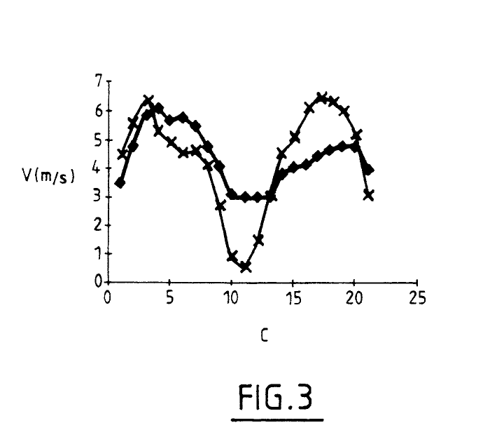

FIG. 3 also well illustrates the effects of the invention on a cell element of a stack fuel cell. Specifically, this FIG. 3 represents the two curves of velocity profiles of the cooling gas (velocity V in m/s on the X axis) of the different channels C (numbered 1 to 21 on the Y axis) of a cell element situated in the extension of the central axis of the fan.

It is easy to note that, according to the invention (represented by dots), the velocities in the cooling channels are more even than without the stator 3 according to the invention (represented by crosses).

This evening-out of the cooling airstream in the channels on the thermics of a cell element is advantageous to the operation of the fuel cell. Specifically, the invention makes it possible to reduce the temperature gradient within a membrane electrode assembly (MEA) of a cell element. In particular the invention makes it possible to reduce the maximum local temperature of such a membrane electrode assembly (typically 4° K: 329° K compared with 333° K for a system without the invention). The invention has little or no effect on the cell elements that were already helped in the airstream (their maximum temperature remains stable (typically around 322° K)).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A fuel cell comprising:
a plurality of adjacent cell elements forming a stack of cell elements;
at least one gas generator adapted and configured to produce a flow of coolant gas along an axis to cool said stack of cell elements by forced heat exchange with the coolant gas; and
at least one gas flow stator member placed between the stack of cell elements and the gas generator, the at least one flow stator member comprising at least one static blade formed to reduce unevenness of a rate of the coolant gas flow in a direction substantially perpendicular to the axis before it arrives at the stack, wherein the gas generator is a blowing rotor comprising at least one rotating blade connected to a rotating hub and wherein the at least one blade is curved in order to redirect a portion of the coolant gas flow situated relatively distant from the axis to a zone of the coolant gas flow situated relatively closer to the axis.

2. The fuel cell of claim 1, wherein the blade or blades of the at least one flow stator member are curved in a first direction substantially perpendicular to the axis and in a second direction substantially parallel to the axis.

3. The fuel cell of claim 1, wherein the gas generator is spaced from the stack at a distance of between 15 and 60 mm.

4. The fuel cell of claim 1, wherein the at least one flow stator member is spaced from the stack at a distance of more than 10 mm.

5. The fuel cell of claim 1, wherein the at least one flow stator member comprises a plurality of static blades curved in a symmetrical manner about an axis of revolution substantially indistinguishable from the axis.

6. The fuel cell of claim 1, wherein the at least one flow stator member comprises at least three static blades.

7. The fuel cell of claim 5, wherein the static blades of the stator member are each connected to an outer frame.

8. The fuel cell of claim 1, wherein:
the at least one gas generator comprises several adjacent gas flow generators designed to cool corresponding adjacent zones of the stack; and
the at least one flow stator member comprises several gas flow stator members each one of which is associated with a different one of the several adjacent gas flow generators.

9. The fuel cell of claim 1, wherein the cells are of the proton-exchange membrane type.

10. The fuel cell of claim 1, wherein the coolant gas is air.

11. The fuel cell of claim 1, wherein the at least one flow stator member comprises six to eight static blades.
